(19) United States
(12) Patent Application Publication
(10) Pub. No.: US 2004/0123994 A1
(43) Pub. Date: Jul. 1, 2004

(54) Method and structure for suppressing EMI among electrical cables for use in semiconductor test system

(76) Inventors: Gert K. G. Hohenwater, Monona, WI (US); Douglas D. Lefever, Evanston, IL (US)

Correspondence Address: MURAMATSU & ASSOCIATES, Suite 225, 7700 Irvine Center Drive, Irvine, CA, 92618, US

(21) Appl. No.: 10/331,563

(22) Filed: Dec. 30, 2002

(51) Int. Cl. H01B 7/29

(52) U.S. Cl. 174/36

(57) ABSTRACT

A method and structure for suppressing EMI, especially cross talks among electrical cables, is incorporated in a semiconductor test system, thereby achieving high test reliability and high test speed at low cost. The noise suppression structure includes an electrical cable, a ferrite core attached to the electrical cable to suppress noise among adjacent cables, and means for attaching the ferrite core around the electrical cable. Another aspect is a method for producing the noise suppression structure in the foregoing.

### FILED OF THE INVENTION

This invention relates to a semiconductor test system for testing semiconductor devices such as ICs and LSIs, and more particularly, to a method and structure using ferrite-beads for suppressing EMI, especially cross talk among electrical cables incorporated in the semiconductor test system, thereby achieving high test reliability and high test speed with low cost.

### BACKGROUND OF THE INVENTION

In general, various noises arise in electrical circuits or in interface cables between circuit boards which frequently cause serious problems when operating an electrical system. Especially, when testing semiconductor devices, such as packaged integrated circuit (IC or LSI), semiconductor wafers, and the like, such noise problems easily could happen. This is because a typical test system has a large number of cables and circuit boards installed therein while signals to and from the semiconductor device under test have to be evaluated with high resolution. Before mentioning such noise issues, a semiconductor test system to which the present invention is applied will be briefly described here.

When testing a large number of semiconductor devices, a semiconductor test system, sometimes called an LSI tester or IC tester, is usually connected to an automatic handler to automatically feed the semiconductor devices to a test location and sort the tested devices based on the test result. When the semiconductor devices to be tested are in the form of a semiconductor wafer, a wafer prober is connected to a test head of the semiconductor test system. The wafer prober automatically provides a semiconductor wafer to a predetermined test position and returns the tested semiconductor wafer based on the test result.

FIG. 1 shows an example of a combination of a semiconductor test system and a wafer prober. The semiconductor test system has a test head 100 which is ordinary in a separate housing and electrically connected to the test system with a bundle of cables 110. The test head 100 and a wafer prober 400 are mechanically as well as electrically connected with each other. The semiconductor wafers to be tested are automatically provided to a test position of the test head 100 by the wafer prober 400.

On the test head, the semiconductor wafer to be tested is provided with test signals generated by the semiconductor test system. The resultant output signals from the semiconductor wafer under test (IC circuits formed on the semiconductor wafer) are transmitted to the semiconductor test system. In the semiconductor test system, the output signals are compared with expected data to determine whether the IC circuits on the semiconductor wafer function correctly or not.

FIG. 2 shows the connection between the test system and the wafer prober in more detail. The test head 100 and the wafer prober 400 are connected through an interface component 140 consisting of a performance board 120, signal cables such as coaxial cables, a pin block structure including a pogo-pin block 130 and contact pins (pogo-pins) 141. The test head 100 includes a large number of printed circuit boards 150 which correspond to the number of test channels (test pins) of the semiconductor test system. Each of the printed circuit boards 150 has a connector 160 to receive a corresponding contact terminal 121 of the performance board 120.

The pogo-pin block 130 is mounted on an upper surface of a frame (not shown) of the wafer prober 400. A large number of pogo-pins 141 are mounted on the pogo-pin block 130 where each of the pogo-pins 141 is connected to the performance board through the cable 124. As is well known in the art, a pogo-pin is a compressive contact pin having a spring therein to achieve electrical connection with sufficient elasticity. The pogo-pin block 130 is to accurately hold the pogo-pins 141 relative to the wafer prober 400.

In the wafer prober 400, a semiconductor device, such as a semiconductor wafer 300 to be tested, is mounted on a chuck 180. In this example, a probe card 170 is provided above the semiconductor wafer 300 to be tested. The probe card 170 has a large number of probe contactors or probe element to contact with contact targets such as circuit terminals or contact pads in the IC circuit of the semiconductor wafer 300 under test.

Contact pads (electrodes) are provided on the upper surface of the probe card 170 which are electrically connected to the pogo-pins 141 when the pogo-pin block 130 is pressed against the probe card 170. Because each pogo-pin 141 is configured to be elastic in the longitudinal direction by the spring therein, it is able to overcome the planarization problem (unevenness of the surface flatness) involved in the system such as probe card, wafer prober frames, and the like.

In this example, the pogo-pins 141 are also connected to the contact terminals 121 of the performance board 120 through the coaxial cables 124 wherein each contact terminal 121 of the performance board 120 is connected to the printed circuit boards 150 of the test head 100. Further, the printed circuit boards 150 are connected to the semiconductor test system through the cable 110 having several hundreds of inner cables.

The probe contactors 190 contact the contact pads on the surface (contact targets) of the semiconductor wafer 300 on the chuck 180 to apply test signals to the semiconductor wafer 300 and receive the resultant output signals from the wafer 300. The resultant output signals from the wafer 300 under test are compared with the expected data generated by the semiconductor test system to determine whether the IC circuits on the semiconductor wafer 300 function correctly or not.

In such a semiconductor test system, a large number of test channels, such as several hundreds, are established for testing a semiconductor device having a large number of device pins. Therefore, several hundreds of electrical cables 124 shown in FIG. 2 must be provided within a limited space, which creates a problem of cross talk among the cables. A brief description will be given here regarding the cables 124 between the performance board 120 and the pogo-pin block 130.

In order to eliminate noise effect, coaxial cables are usually used for the interface cables 124. As shown in FIG. 3, a core wire (center conducting wire) 210 of the coaxial cable 124 is used for transmitting electrical signals or power sources and connected to an electrode of the performance board 120. As is well known in the art, a shield wire (outer conducting wire) 211 of the coaxial cable 124 is used for enclosing the core wire 218. The shield wire 211 is connected to the ground of the test system. Thus, the coaxial cable 124 is constituted to shield signals from going outside of the cable as well as to be less susceptible to external influence.

However, since a large number of coaxial cables 124 are confined within a small space formed between the performance board 120 and the pogo-pin block 130, the coaxial cables 124 tend to receive noises from other coaxial cables such as cross talk noises since the shielding effect of the coaxial cables is not perfect. Further, the semiconductor test system generates test signals (test patterns) of high frequency to test high speed semiconductor devices. Thus, impulses of high frequency components are travelling through the coaxial cables which easily create cross talk noises. Furthermore, since the modern semiconductor devices use signals of small voltage or current levels, even small noises may be a serious factor for achieving reliable and accurate test result.

In general, the smooth flow of power or signal from one to another circuit board requires an impedance matching to minimize reflection in a high frequency range. Therefore, the impedance matching are taken care of by the coaxial cables 124 to keep the signals in good condition. However, in the case of high speed testing, serious noise will be generated by slight impedance mismatching between the coaxial cables 124 and the circuit connected thereto, imperfect shielding and so on because of the high frequency components are associated with the test. Even a small level of noise may cause serious problems because the signal levels of the device under test is small. Therefore, there is a need of a simple and low cost way to suppress the noise from the cables in the semiconductor-test system.

### SUMMARY OF THE INVENTION

Therefore, it is an object of the present invention to provide an improved method and structure for suppressing noises associated with the electric cables used in the semiconductor test system.

It is another object of the present invention to provide a method and structure to reduce cross talk noise associated with the coaxial cables interfacing between the performance board and the pogo-pin block in the semiconductor test system in order to achieve a secure high speed testing.

It is a further object of the present invention to provide a method and structure to reduce EMI (electro-magnetic interference) among coaxial cables used in the semiconductor test system by mounting a ferrite-beads noise filter on each coaxial cable.

One aspect of the present invention is a noise suppression structure for use in a semiconductor system. The noise suppression structure includes an electrical cable, a ferrite core attached to the electrical cable to suppress noise among adjacent cables, and means for attaching the ferrite core around the electrical cable.

Typically, the electrical cable is a coaxial cable running between a pogo-pin block and a printed circuit board. The means for attaching the ferrite core is a heat shrink tube which fixedly attaches the ferrite core around the electrical cable by a shrinking force when the heat shrink tube is heated. The printed circuit board is a performance board having circuit patterns unique to a semiconductor device under test and a means for mounting the semiconductor device under test thereon.

Preferably, the ferrite core is attached to an end portion of the electrical cable. The ferrite core has a tubular shape into which the electrical cable is inserted, and the ferrite core has many ferrite beads therein to function as a noise filter.

Another aspect of the present invention is a method for producing a noise suppression assembly which is configured in the manner described above.

### BRIEF DESCRIPTION OF THE DRAWINGS

FIG. 1 is a schematic diagram showing an example of structural relationship between a wafer prober and a semiconductor test system having a test head.

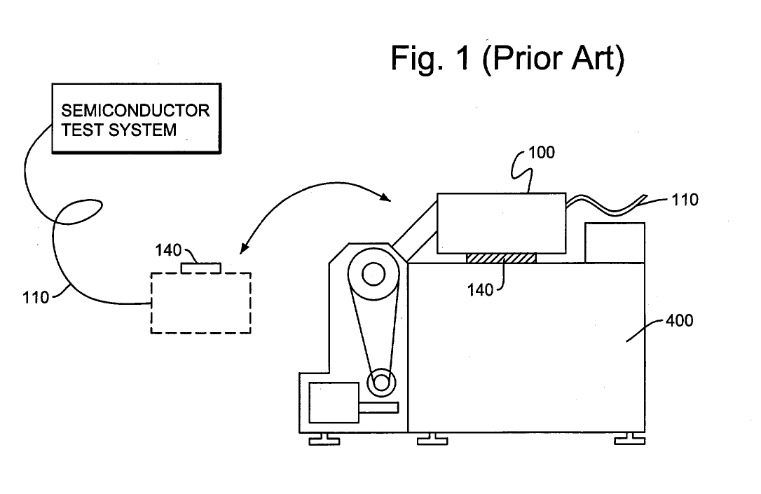

FIG. 2 is a diagram showing an example of detailed structure for interfacing between the test head of the semiconductor test system and the wafer prober.

FIG. 3 is a schematic diagram showing coaxial cables connecting between a performance board and a pogo-pin block in the semiconductor system.

FIG. 4 is a schematic diagram showing a noise suppression method and structure of the present invention using a ferrite-beads filter which is attached around each coaxial cable of FIG. 3.

FIGS. 5A-5C are schematic diagrams showing an example of process for attaching a ferrite-beads filter in which FIG. 5A shows components involved for attaching the ferrite-beads filter to the coaxial cable, FIG. 5B shows an assembled configuration before a shrink tube is heated by a heat gun, and FIG. 5C shows an assembled configuration after the shrink tube is heated by the heat gun.

### DETAILED DESCRIPTION OF THE INVENTION

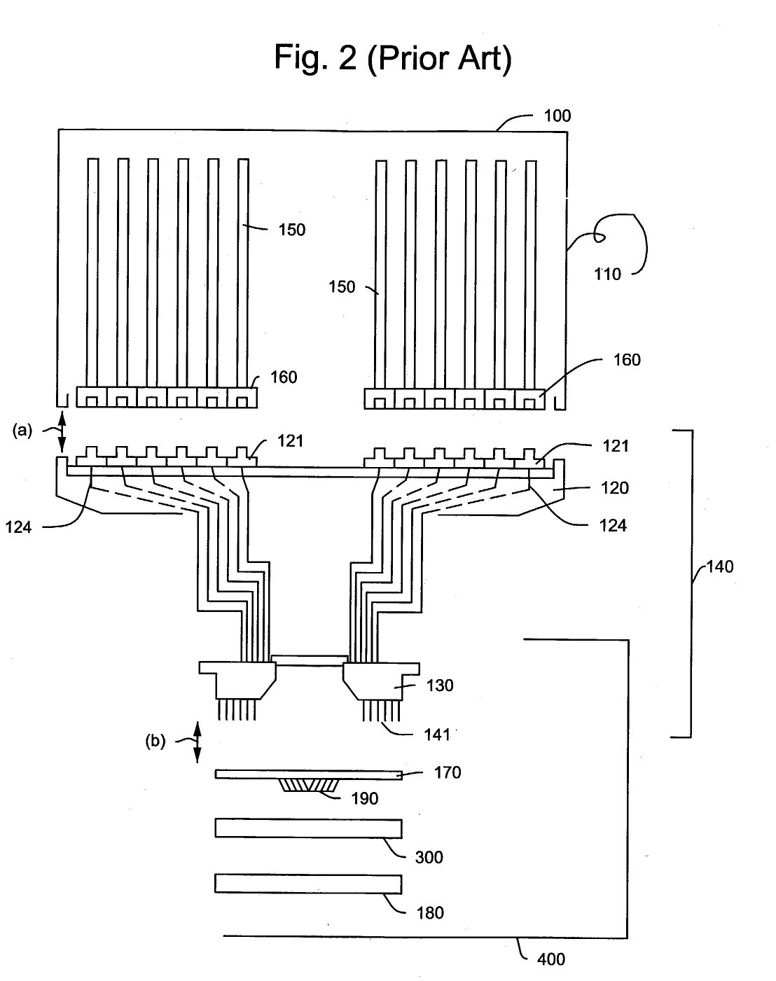

As described in the background of the invention, in a typical semiconductor test system, a large number of coaxial cables such as several hundreds of them, are provided between the performance board 120 and the pogo-pin block 130 as shown in FIG. 2. Because of such a large number of cables have to be confined in a small space, ordinarily, the coaxial cables are bundled together as several groups. Various test signals, clocks, source power and ground currents to perform semiconductor testing are transmitted through the coaxial cables.

Moreover, the speed of clocks and test patterns in the semiconductor have become faster and faster while signal levels in the semiconductor device under test have become smaller and smaller. Therefore, in the arrangement where many coaxial cables are used in the limited space, the test signals becomes more and more susceptible to EMI such as cross talk noise. The present invention provides an easy, low cost, yet highly effective solution to these EMI problems involved in the semiconductor test system.

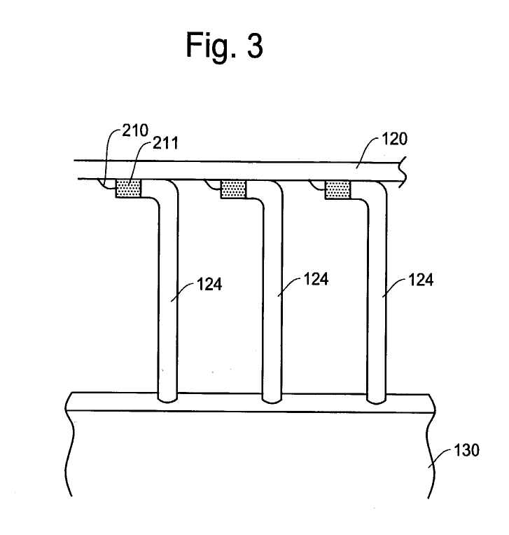

The basic configuration regarding the interface between the performance board 120 and the pogo-pin block 130 is shown in FIG. 3. A core wire (center conducting wire) 210 of the coaxial cable 124 is connected to an electrode on the performance board 120 and a shield wire (outer conducting wire) 211 is connected to the shield ground of the semiconductor test system through the performance board. The core wire 210 and the shield wire 211 at other end of the coaxial cable 124 are connected to the pogo-pin block 130 (not shown). As mentioned in the background of the invention, the smooth flow of power or signal from one board to another requires an impedance matching between an impedance of a transmission line (coaxial cable 124) and an input impedance of a circuit connected (the electrode on the performance board 120).

Therefore, in this case, the impedance matching between the performance board 120 and the coaxial cable 124 and between the coaxial cable 124 and the pogo-pin block 130 are necessary to keep the quality of signals in good condition. However, slight mismatching between these components happens in an actual application. When there is such an impedance mismatching between the coaxial cables and the circuit connected to the coaxial cables, the reflection in high frequency spectrum region happens at the end of the coaxial cable which produces a standing wave.

Since the frequency band used in the semiconductor test system is high, such standing waves is harmful because it causes serious EMI problem such as cross talk noise among the cables. Furthermore, when a relatively large current flows in the ground adjacent to the coaxial cables, the ground ringing happens through the shield wire of the coaxial cable, which will also cause cross talk noise among coaxial cables.

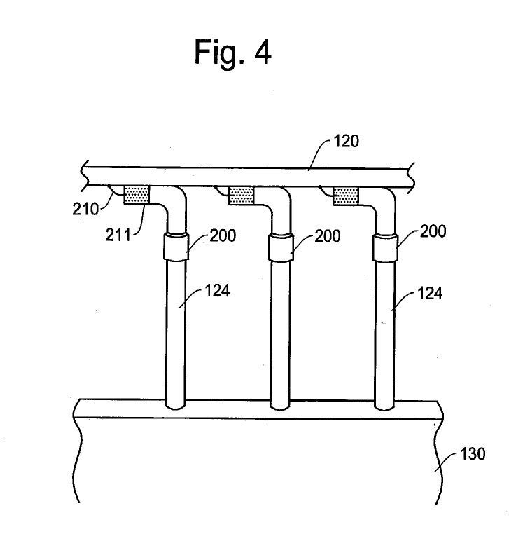

In order to eliminate the cross talk noise, in the present invention, a ferrite-beads noise filter is used for each coaxial cable 124 because of its isolation property to the reflection in high frequency region. As shown in FIG. 4, preferably, a ferrite-beads filter (ferrite filter) 200 with a ring shape is used for the coaxial cable 124 in this example. The ferrite filter 200 is preferably located closely to the end of the coaxial cable 124 (in this case, close to the performance board 120) as shown in FIG. 4. This location usually allows the ferrite filter 200 to effectively filter out the reflection caused by an impulse current in the coaxial cable 124.

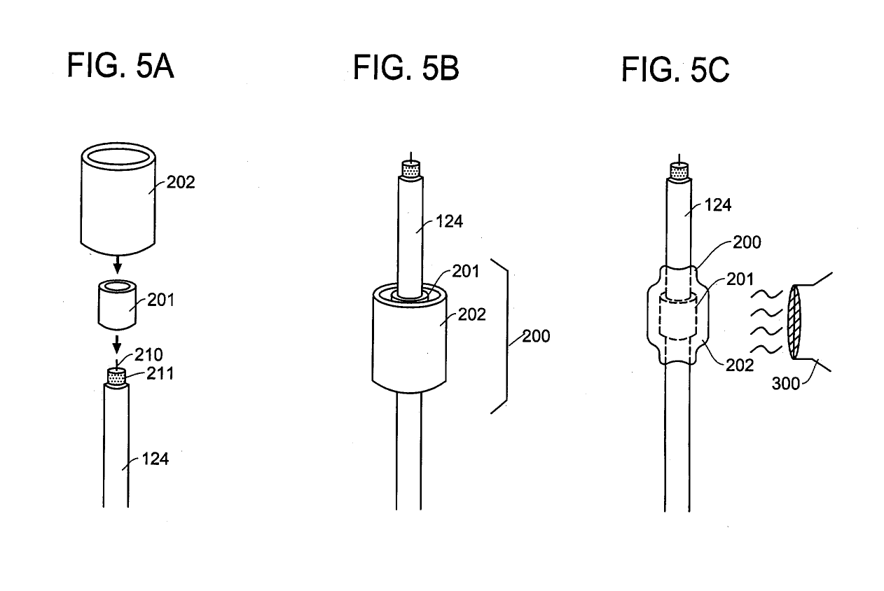

FIGS. 5A-5C are schematic diagrams showing examples of process for assembling the ferrite filter 200 with the coaxial cable 124. Obviously, the method of attaching the ferrite filter to the coaxial cable 124 is not limited to the one disclosed here, but there are many other ways of attaching the ferrite filter to the coaxial cable. For example, an adhesive may be used for attaching and holding the ferrite core 200 to the coaxial cable 124.

Here, the method of using a piece of shrink tube is explained as an illustration purpose to show how the ferrite filter 200 is attached to the coaxial cable 124. FIG. 5A shows components involved in the attachment process of the ferrite filter 200. Such components are the coaxial cable 124, a ferrite core (ferrite ring) 201 and a heat shrink tube 202. The heat shrink tube 202 is well known in the art as a part of electrical wiring.

At an end of the coaxial cable 124, the shell (outer jacket) is removed to expose the core wire 210 and the shield wire 211 as shown in FIG. 5A to connect the coaxial cable 124 to the performance board 120 (FIG. 4). In this example, the ferrite 201 with the shape of ring is used, is called a “ferrite core”. The inner diameter of the ferrite core 201 must be slightly larger than the outer diameter of the coaxial cable 124.

The ferrite core is also well known in the art, and many manufacturers offer customers to develop and make special ferrite cores for EMI control of customer's particular application. For example, some ferrite cores are designed to control terminal noise ranging from 10 MHz to 30 MHz in frequency and suited for the control of unnecessary noise from 30 MHz up to 500 MHz. Namely, the characteristics of ferrite core is carefully selected or developed in the present invention based on the clock rate, signal levels and other factors. Also, various shapes of ferrite are available to match customer's needs.

FIG. 5B shows the configuration of the ferrite filter 200 before the shrink tube 202 is shrunk by a heat gun 300. The length of the shrink tube 202 should be long enough to sufficiently and air-tightly wrap the ferrite core 201 on the coaxial cable 124. Also, the diameter of the shrink tube 202 should be appropriate size so that the force of holding the ferrite core 201 is large enough after the shrink tube 202 is shrunk.

FIG. 5C shows the configuration of the ferrite filter 200 after the shrink tube 202 is heated by the heat gun 300. By attaching the ferrite core 201 to every coaxial cable in the same manner, the suppression effect to the cross talk is increased because the ferrite cores of adjacent coaxial cables reduce the noise level caused by the reflection (which is caused by the impulse current when there is impedance mismatching). Under this arrangement, the cross talk between coaxial cables 124 confined in the space formed between the performance board 120 and pogo-pin block 130 can be substantially reduced or eliminated.

As has been described above, according to the present invention, it is possible to easily achieve an improved method and apparatus for suppressing noises associated with the cables used in the semiconductor test system. The present invention is able to effectively reduce the cross talk noise associated with the coaxial cables interfacing between the performance board and the pogo-pin block in the semiconductor test system in order to achieve a secure high speed testing. As described above, the EMI suppression method and structure of the present invention is achieved by mounting the ferrite-beads noise filter (ferrite core) on each coaxial cable.

Although only preferred embodiments are specifically illustrated and described herein, it will be appreciated that many modifications and variations of the present invention are possible in light of the above teachings without departing the spirit and intended scope of the invention.

What is claimed is:

1. A noise suppression structure for use in a semiconductor system comprising;
an electrical cable;
a ferrite core attached to the electrical cable to suppress noise among adjacent cables; and
means for attaching the ferrite core around the electrical cable.

2. A noise suppression structure as defined in claim 1, wherein said electrical cable is a coaxial cable running between a pogo-pin block and a printed circuit board.

3. A noise suppression structure as defined in claim 1, wherein said means for attaching the ferrite core is a heat shrink tube which fixedly attaches the ferrite core around the electrical cable by a shrinking force when the heat shrink tube is heated.

4. A noise suppression structure as defined in claim 1, wherein said ferrite core is attached to an end portion of the electrical cable.

5. A noise suppression structure as defined in claim 1, wherein said ferrite core has a tubular shape into which the electrical cable is inserted, and said ferrite core has many ferrite beads therein to function as a noise filter.

6. A noise suppression structure as defined in claim 1, wherein said printed circuit board is a performance board having circuit patterns unique to a semiconductor device under test and means for mounting the semiconductor device under test thereon.

7. A method for making a noise suppression assembly between a performance board and a pogo-pin block in a semiconductor system, comprising a step of mounting a ferrite core on an electrical cable running between the performance board and the pogo-pin block.

8. A method for making a noise suppression assembly as defined in claim 7, wherein said step of mounting the ferrite core on the electrical cable includes a step of covering the ferrite core on the electrical cable by a heat shrink tube and heating the heat shrink tube.

9. A method for making a noise suppression assembly as defined in claim 7, wherein said step of mounting the ferrite core on the electrical cable includes a step of attaching the ferrite core to the ferrite with use of an adhesive therebetween.

10. A method for making a noise suppression assembly as defined in claim 7, wherein the electrical cable is a coaxial cable.
